(19) United States
(12) Patent Application Publication
(10) Pub. No.: US 2023/0092277 A1
(43) Pub. Date: Mar. 23, 2023

(54) SYSTEM, METHOD FOR INDICATING MECHANICAL PROPERTIES AND COMPUTER-READABLE STORAGE

(71) Applicant: Heraeus Amloy Technologies GmbH, Hanau (DE)

(72) Inventors: Hans-Jürgen WACHTER, Karlstein (DE); Eugen MILKE, Karlstein (DE); Hamed SHAKUR SHAHABI, Karlstein (DE); Florian THEISEN, Hanau (DE); Michael KLOSCH-TRAGESER, Freigericht (DE)

(21) Appl. No.: 17/905,025

(22) PCT Filed: Feb. 17, 2021
(86) PCT No.: PCT/EP2021/053870

§ 371 Date: Aug. 25, 2022

(30) Foreign Application Priority Data
Feb. 25, 2020 (EP) 20159314.2

(51) Int. Cl. G06F 30/23

(52) U.S. Cl. CPC G06F 30/23; G06F 2119/08

(57) ABSTRACT

The invention relates to a system and method for indicating mechanical properties, and to a computer-readable storage medium, the system having a simulation unit which is designed to determine a cooling behavior of at least a part of a component to be produced, said component having amorphous properties, a computing unit which is designed to determine at least one amorphicity value at least for a part of the component to be produced, taking account of the determined cooling behavior, a prediction unit which is designed to indicate mechanical properties of the component to be produced, taking account of a geometry of the component to be produced, the at least one amorphicity value, at least one production parameter and/or a production method.

The invention relates to a system, a method for indicating mechanical properties for a component to be produced and a corresponding computer-readable storage medium.

Amorphous metals are a novel material class which have physical properties or combinations of properties that cannot be realized in other materials.

Amorphous metals are referred to when metal alloys have an amorphous structure rather than a crystalline structure at the atomic level. The amorphous arrangement of atoms, which is unusual for metals, leads to unique combinations of physical properties. Amorphous metals are generally harder, more corrosion-resistant and stronger than conventional metals with, at the same time, high elasticity. Thus, no different surface potentials arise so that no corrosion can arise.

Metallic glasses have been the subject of extensive research since their discovery at the California Institute of Technology. Over the years, the processability and properties of this material class were continuously improved. Whereas the first metallic glasses were simple, binary alloys, the production of which required cooling rates in the range of 106 Kelvin per second, newer, more complex alloys can be converted to a vitreous state at significantly lower cooling rates in the range of a few K/s. This has a significant impact on process management and on the workpieces that can be realized. The cooling rate from which crystallization of the melt does not occur and the melt solidifies in a vitreous state is referred to as the critical cooling rate. The critical cooling rate is a system-specific variable, which is strongly dependent on the composition of the melt and which additionally defines the maximum achievable component thicknesses. When considering that the thermal energy stored in the melt has to be transported away through the system sufficiently quickly, it becomes clear that only workpieces of a small thickness can be produced from systems with high critical cooling rates. Initially, metallic glasses were therefore typically produced according to the melt spinning method. In this case, the melt is scraped off onto a rotating copper wheel and solidifies in a vitreous manner in the form of thin ribbons or foils with thicknesses in the range of a few hundredths to tenths of a millimeter. As a result of the development of new, complex alloys with significantly lower critical cooling rates, other production methods can increasingly be used. Current solid glass-forming metallic alloys can already be converted to a vitreous state by casting a melt in cooled copper molds. In this case, the realizable component thicknesses are in the range of a few millimeters to centimeters, depending on the alloy. Such alloys are referred to as solid metallic glasses. Nowadays, a large number of such alloy systems is known.

Solid metallic glasses are usually categorized based on the composition, wherein the alloying element with the highest percentage by weight is referred to as the base element. The existing systems comprise, for example, precious metal-based alloys, such as gold, platinum, and palladium-based solid metallic glasses, early transition metal-based alloys, such as titanium-based or zirconium-based solid metallic glasses, late transition metal-based systems based on copper, nickel or iron, but also systems based on rare earths, for example neodymium or terbium.

Solid metallic glasses typically have the following properties in comparison to classic crystalline metals:
a higher specific strength, which, for example, allows thinner wall thicknesses,
a greater hardness, as a result of which the surfaces can be particularly scratch-resistant,
a much higher elastic extensibility and resilience,
thermoplastic moldability, and
greater corrosion resistance.

Due to their advantageous properties, such as high strength, and the absence of solidification-induced shrinkage, metallic glasses, in particular solid metallic glasses, are very interesting construction materials which are suitable, in principle, for producing components in series production methods, such as injection molding, without further processing steps being absolutely necessary after molding has taken place. In order to prevent crystallization of the alloy from the melt during cooling, a critical cooling rate must be exceeded. However, the greater the volume of the melt, the more slowly the melt cools. If a specific sample thickness is exceeded, crystallization occurs before the alloy can solidify amorphously.

In addition to the excellent mechanical properties of metallic glasses, the vitreous state also gives rise to unique processing possibilities. Thus, metallic glasses can be molded not only by means of metallurgical melting methods but also by means of thermoplastic molding at comparatively low temperatures in a manner analogous to thermoplastic plastics or silicate glasses. In this respect, the metallic glass is first heated above the glass transition point and then behaves like a highly viscous liquid which can be deformed with relatively low forces. After the deformation, the material is again cooled below the glass transition temperature.

During the processing of amorphous metals, natural crystallization is prevented by rapid cooling of the melt so that the mobility of the atoms is removed before they can adopt a crystal arrangement. Many properties of crystalline materials are influenced or determined by faults in the atomic structure, so-called lattice defects.

As a result of the rapid cooling, the shrinkage of the material is reduced so that, in the case of amorphous metals, more precise component geometries can be achieved. Plastic deformation only takes place with elongations above 2%. By comparison, crystalline metallic materials generally become irreversibly deformed, even with significantly smaller elongations. The combination of high yield strength with high elastic elongation also results in a high storage capacity for elastic energy.

However, the thermal conductivity of the material used physically limits the cooling rate since the heat contained in the component must be released to the environment via the surface. This leads to limitations in the producibility of components and in the applicability of production methods.

Various methods for producing workpieces from amorphous metals are known. Thus, it is possible to produce workpieces using additive manufacturing methods, such as 3D printing. The amorphous properties of the workpiece can be ensured by adjusting the process parameters, such as the scan speed, the energy of the laser beam or the pattern to be followed.

One advantage of additive manufacturing technology is that, in principle, any conceivable geometry can be realized. Furthermore, it can be advantageous that additive manufacturing methods do not require a separate cooling process since good cooling can be ensured by the layer-by-layer production of the workpiece and an adjustment of the size of the melt pool via laser energy and travel path of the laser.

A disadvantage of additive manufacturing methods are the low build-up rates at the time of application, especially with large-scale workpieces. Furthermore, high-purity powder material must be used as starting material for the additive manufacturing process. If impurities are present in the material, crystallization, i.e., non-amorphous metal, can occur at the impurity sites, which can lead to a deterioration of the mechanical and chemical properties. Near to the surface, it may be necessary due to the impurity to rework the workpiece, which is complex. In addition, additive manufacturing always results in a certain roughness on the surface of the workpiece so that the latter has to be reworked in most cases by grinding or milling.

Injection molding offers a further manufacturing possibility. In this case, weights of workpieces in the range of 80-100 g can be realized at the time of application. The material to be used is usually heated by inductive heating to about 1050° C. within about 20 seconds and homogenized.

After heating, the molten material is pressed into a mold by means of a stamp. It is important for the material properties that if the mold is completely filled with material, the material within the mold should have a temperature everywhere that is above the material melting point. In order to achieve amorphous material properties, the liquid material within the mold must subsequently be cooled rapidly to below the glass transition temperature.

The possible geometries during injection molding are limited to wall thicknesses of 0.3-7.0 mm due to the cooling rate of the material. With greater wall thicknesses, the cooling rate is too low so that crystalline structures form before the material has cooled to below the glass transition temperature. With smaller wall thicknesses, the material cools too quickly depending on the length to be filled and solidifies before the mold is filled.

In order to ensure in advance during construction, dimensioning, selection of the alloy material, selection of the production method or the like that the amount of heat supplied to the material can be released sufficiently quickly to the environment, the cooling behavior can be simulated and analyzed.

Many framework conditions have to be taken account of when selecting a suitable alloy or the alloy quality for a component to be produced and the specific application thereof. The alloy quality is defined either by the proportion of recycling material or by the ratio of amorphous and crystalline fractions in the alloy. A lower-quality alloy no longer has 100% amorphous properties. Thus, a component with low alloy quality cannot be used for every load case.

It is therefore necessary to know the mechanical properties of a component to be produced before a component is produced.

DE 10 2009 034 840 discloses a method for predicting the fatigue strength of metal alloys at very high cycle numbers. In the method, it is assumed that at least one fatigue crack initiation site is present. Taking account of the fatigue crack initiation site, the fatigue strength is calculated using a modified stochastic fatigue limit model.

A disadvantage of the solution of DE 10 2009 034 840 is that no information can be obtained as to how the fatigue strength can be specifically improved.

DE 10 2015 110 591 discloses a system for predicting material properties of a cast aluminum-based component. However, the specific properties and production conditions of amorphous metals are not taken account of in this case.

EP 2595073 discloses a method for optimizing a cast component. In the solution of EP 2595073, however, no homogeneous material quality is achieved.

Proceeding from this prior art, it is therefore the object of the invention to improve the production of components having amorphous properties. It is the object of the invention, in particular, to indicate mechanical properties of components that are to be produced, said components having amorphous properties. It is further in particular an object of the invention to select a suitable alloy for a component to be produced.

The object is achieved by a system according to claim 1, a method according to claim 10, and by a computer-readable storage medium according to claim 19.

In particular, the object is achieved by a system having the following:
a simulation unit which is designed to determine a cooling behavior of at least a part of a component to be produced, said component having amorphous properties;
a computing unit which is designed to determine at least one amorphicity value at least for a part of the component to be produced, taking account of the determined cooling behavior;
a prediction unit which is designed to indicate mechanical properties of the component to be produced, taking account of a geometry of the component to be produced, the at least one amorphicity value, at least one production parameter, and/or a production method.

A core concept of the invention is that the mechanical properties of the component to be produced can be specified before the actual production. This is made possible in that the cooling behavior is determined at least for a part of the component to be produced and the mechanical properties can be derived therefrom. In particular in the case of components which are supposed to have amorphous material properties, the cooling rate or the cooling behavior during production is crucial. If a critical cooling rate is not achieved, undesirable crystalline structures occur. Moreover, the formation of crystalline structures depends on the alloy used. As described in detail, the impurities of the material used can serve as nucleating agents and thus lead to crystalline structures. With the invention, it is possible to predict the mechanical properties of the component to be produced, taking account of all said properties and parameters. Thus, a decision can be taken as to the purposes for which the component to be produced is suitable.

The amorphicity value can indicate which degree of amorphous properties a component has. For example, smaller crystalline structures within the component can bring about a reduction in the amorphicity value. The use of an amorphicity value is based on the consideration that it is virtually impossible in practice to construct a component which has 100% amorphous properties. It is now possible to also indicate gradations of an amorphicity value. In particular, the invention makes it possible to derive mechanical properties of a component from said gradations.

In one embodiment, the system may comprise a database unit which can be designed to store assignments of material properties and/or material information to amorphicity values.

A database unit can be used to assign different material properties to different amorphicity values. For example, in one embodiment, the database can store information about a tensile strength, a flexural strength, a cycle stability and/or viscosity data. This information can be assigned to amorphicity values and/or materials. The prediction unit can thus be designed to read material properties from the database that relate to a specific material and/or the determined amorphicity value. Furthermore, it is possible for the prediction unit to be designed to derive mechanical properties of the component to be produced for a determined amorphicity value and assigned material properties.

The data stored in the database unit can be determined by experiments. In this case, produced components can be examined in the laboratory in terms of their material properties so that the database contains realistic measured values. Furthermore, it is conceivable to additionally or alternatively store simulated data in the database unit.

In one embodiment, the computing unit can further be designed to determine a cooling rate for at least a part of the component to be produced, taking account of the determined cooling behavior.

In the embodiment described, it is possible that a cooling rate is initially determined for a part of the component to be produced, taking account of the simulated cooling behavior. Thus, a cooling rate can also be determined for a part of the entire component so that it is also possible to assign different amorphicity values to different parts of a component. In particular, it is conceivable that the component to be produced is divided into a plurality of sub-regions, wherein the computing unit can be designed to indicate an individual amorphicity value for each of the sub-regions. It is thus possible to indicate material properties, production parameters and mechanical properties of the component to be produced for individual sub-regions of the component to be produced.

In one embodiment, the computing unit can further be designed to compare a/the determined cooling rate with a critical cooling rate, in particular one that is alloy-dependent, wherein the computing unit can be designed to carry out the determination of the amorphicity value, taking account of the comparison.

A critical cooling rate can be used to determine whether amorphous properties are achieved during the manufacture of the component to be produced. This critical cooling rate can be stored, for example, by the database unit together with an associated alloy or an associated material. The amorphicity value can be determined by comparing the cooling rate with the critical cooling rate.

In one embodiment, the database unit can be designed to store an assignment of material properties to critical cooling rates and/or amorphicity values.

In order to determine the mechanical properties of the component to be produced, the database unit can store corresponding material properties for critical cooling rates and/or amorphicity values. This makes it possible for the prediction unit to read corresponding material properties from the database unit.

In one embodiment, the component to be produced can be indicated by a component description, in particular by a CAD model, wherein the simulation unit can be designed to carry out the determination of the cooling behavior using the component description.

In the described embodiment, the component to be produced can be indicated by a component description. A CAD model is in particular suitable for this purpose. A component description can therefore be regarded as a digital representation of the component to be produced. The component description can, for example, comprise information about the materials to be used. In addition, the component description can easily be exchanged between individual system components.

In one embodiment, a/the component description can indicate a plurality of volume elements, wherein the simulation unit can be designed to determine a cooling behavior for at least a part of the volume elements, preferably for all volume elements.

With the described embodiment, it is possible for a cooling behavior to be determined for each volume element or for a part of the volume elements. Furthermore, it is conceivable that the computing unit is designed to determine an amorphicity value for each volume element. In one embodiment, the prediction unit may further be designed to indicate mechanical properties for each volume element or a subset of the volume elements.

In one embodiment, the simulation unit can be designed to determine the cooling behavior, also taking account of an alloy to be used.

The determination of the cooling behavior can be improved if an alloy to be used is taken into account. Furthermore, it is possible for the simulation unit to be designed to calculate the cooling behavior for a plurality of possible alloys. This calculation can be performed sequentially or in parallel. By taking account of one or a plurality of alloys, amorphicity values can be assigned to individual alloys. The prediction unit can be designed to indicate the mechanical properties of the component to be produced for different alloys. This makes it possible for the most suitable alloy for manufacturing the component to be selected. Overall, the manufacture of the component to be produced is thus improved.

In one embodiment, the at least one production parameter may comprise an indication for an injection temperature into a molding chamber and/or an indication for an injection rate into a molding chamber.

When using an injection molding method for producing the component to be produced, the at least one production parameter may comprise, for example, an injection temperature into a molding chamber or also an injection rate into a molding chamber. It is also conceivable for a feed rate of a stamp to be indicated as the at least one production parameter. These parameters have a significant influence on the temperature of the material in the molding chamber and thus on whether or not amorphous properties are achieved.

In one embodiment, the prediction unit can be designed to simulate at least one mechanical load case for the component to be produced, in particular using a/the component description and/or an FEM simulation.

With the described embodiment, it is possible to simulate different load cases for the component to be produced. Thus, by using a simulation, the action of a force at different points of the component can be simulated. Temperature profiles as a result of different environmental influences can also be simulated. Finally, the described embodiment enables the user of the component to be produced, prior to the production of the component, to define load cases which the component must be able to withstand.

In one embodiment, the mechanical properties may comprise an indication of whether the component to be produced withstands the at least one mechanical load case, taking account of the geometry of the component to be produced, the at least one production parameter and/or the production method.

The mechanical properties can thus indicate whether the component to be produced is able to withstand a defined load case or not. The indication can be material-specific or alloy-specific. This means that the mechanical properties of the component to be produced contain an indication for an alloy to be used of whether the defined load cases are possible with the component to be produced.

In one embodiment, the prediction unit can be designed to compare the indicated mechanical properties of the component to be produced with at least one setpoint value. The prediction unit can further be designed to activate the simulation unit when the mechanical properties of the component to be produced deviate from the setpoint value or do not meet the required quality criteria. The simulation unit can be designed to determine, after activation, the cooling behavior for an alloy other than one used previously. In addition or in the alternative, the simulation unit can be designed to determine the at least one amorphicity value for a plurality of different alloys.

By means of the embodiment, feedback is defined which can be carried out until the mechanical properties of the component to be produced correspond to the setpoint value or are better.

In one embodiment, the system may comprise a production plant designed to produce the component to be produced using the at least one production parameter, in particular by an additive manufacturing method or an injection molding method.

It is also possible for the component to be produced to also be produced directly by the described system. Overall, an efficient process chain is thus defined.

In one embodiment, the system may have a user terminal which can be designed to transmit a component description of the component to be produced to the simulation unit via a communication network.

A particular advantage arises if a user can transmit a component description to the simulation unit via a communication network. For example, a user can produce a component description at a user terminal, preferably a computer, for example by means of a CAD application program. Subsequently, the component description can be transmitted to the simulation unit via a communication network, such as the Internet. For this purpose, the simulation unit may have a corresponding communication unit. Furthermore, in one embodiment, it is possible for the communication unit to be designed to transmit the mechanical properties of the component to be produced, which are indicated by the prediction unit, to the user terminal. Thus, a user can immediately recognize whether a component description satisfies desired load cases or can be used as the user wishes.

The object is further achieved in particular by a method for indicating mechanical properties for a component to be produced, said component having amorphous properties and said method having the steps of:
determining a cooling behavior of at least a part of a component to be produced, said component having amorphous properties;
determining at least one amorphicity value at least for a part of the component to be produced, taking account of the determined cooling behavior;
indicating the mechanical properties of the component to be produced, taking account of a geometry of the component to be produced, at least one production parameter, the at least one amorphicity value and/or a production method.

In one embodiment, the method may comprise storing assignments of material properties and/or materials to amorphicity values.

In one embodiment, the method may comprise determining a cooling rate for at least a part of the component to be produced, taking account of the simulated cooling behavior.

In one embodiment, the method may comprise comparing a/the determined cooling rate with a critical cooling rate, in particular one that is alloy-dependent, wherein the amorphicity value can be determined taking account of the comparison.

In one embodiment, the method may comprise storing an assignment of material properties to critical cooling rates and/or amorphicity values, in particular in a database unit.

In one embodiment, the component to be produced can be indicated by a component description, in particular by a CAD model, wherein the cooling behavior can be determined using the component description.

In one embodiment, a/the component description can indicate a plurality of volume elements, wherein determining the cooling behavior may comprise determining the cooling behavior for at least a part of the volume elements, preferably for all volume elements.

In one embodiment, the cooling behavior may also be determined taking account of an alloy to be used.

In one embodiment, the method may comprise simulating at least one mechanical load case for the component to be produced, in particular using a/the component description and/or an FEM simulation.

In one embodiment, the method may comprise producing the component to be produced using the at least one production parameter, in particular by an additive manufacturing method or an injection molding method.

In one embodiment, the method may comprise transmitting a component description of the component to be produced from a user terminal to a simulation unit via a communication network, in particular via a communication network.

The object is further achieved in particular by a computer-readable storage medium containing instructions which cause the at least one processor to implement a method, as described above, when the instructions are executed by the at least one processor.

Similar or identical advantages arise as have already been described in connection with the system.

Further embodiments arise from the dependent claims.

The invention is explained in more detail below using exemplary embodiments. Shown are:

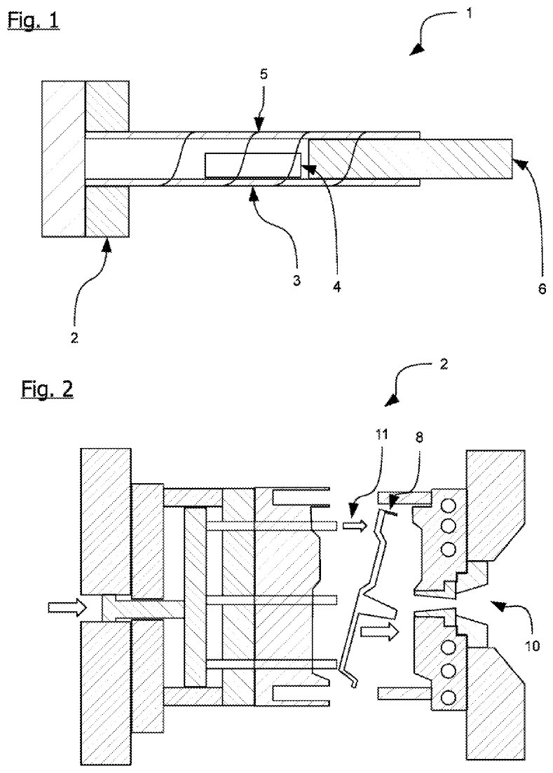

FIG. 1: a schematic representation of an injection molding machine;

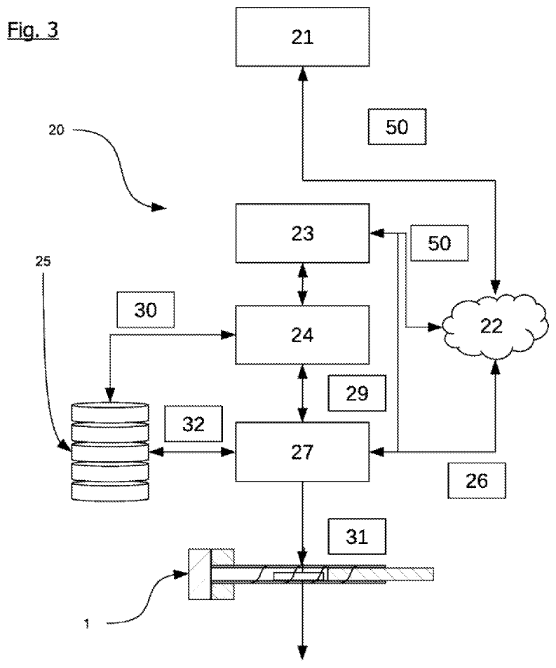

FIG. 2: a schematic representation of a tool;

FIG. 3: a schematic representation of a system;

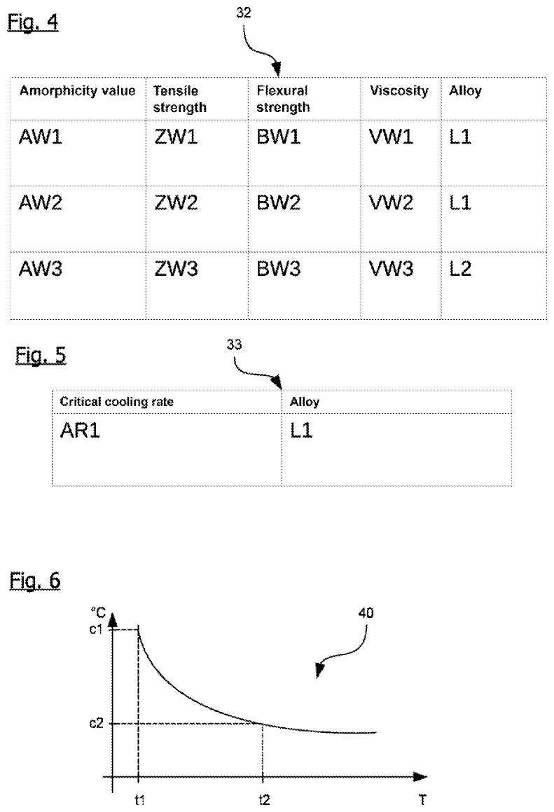

FIG. 4: an exemplary database table;

FIG. 5: a further exemplary database table with critical cooling rates

FIG. 6: a temperature profile for a component;

FIG. 7: an assignment of temperature profiles to volume elements of a component description;

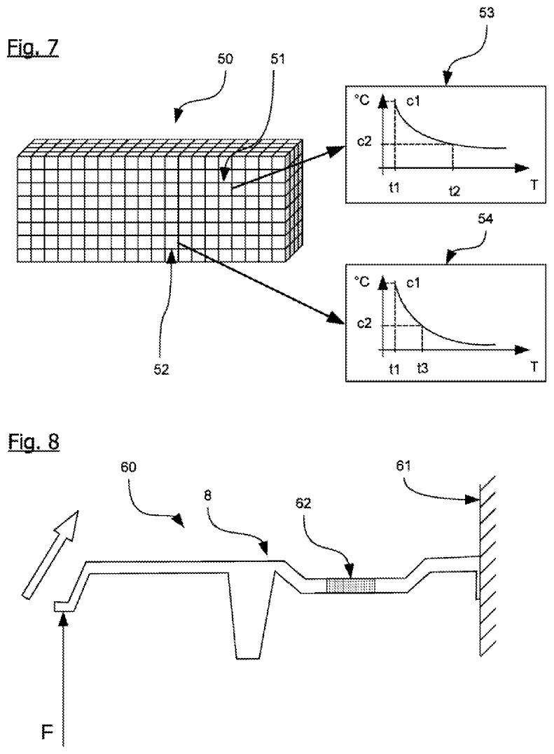

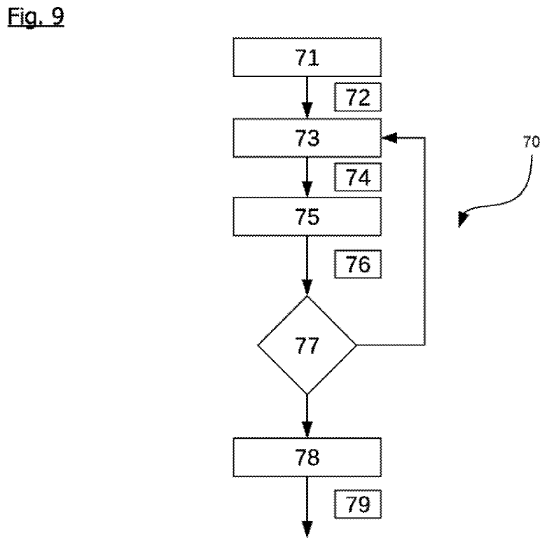

FIG. 8: a representation of a component to be produced with corresponding load cases; and

FIG. 9: a flow chart for a method for producing a component.

In the following, the same reference signs are used for identical or identically acting parts.

FIG. 1 shows a schematic representation of an AMM (amorphous metal) injection molding system 1. The injection molding system 1 comprises a mold in the tool 2 and a melting chamber 3. A solid alloy segment of an amorphously solidifying alloy (blank) 4 is supplied to the melting chamber 3 via a robot and placed centrally in an induction coil 5. The blank 4 is heated within the melting chamber 3 by means of a heating element, in particular an induction field, which is generated by the induction coil 5. The blank 4 is a solid alloy segment of an amorphously solidifying alloy. The alloy segment 4 has, for example, a specific proportion of palladium, platinum, zirconium, titanium, copper, aluminum, magnesium, niobium, silicon and/or yttrium.

The blank 4 is melted by the heating element or the induction coil 5 so that it is in molten form. Preferably, the blank 4 is heated to a temperature of 1050° C. The molten material is injected into the tool 2 by a piston 6.

FIG. 2 shows the schematic structure of an injection molding tool. The molding chamber 11 is filled with a melt by means of one or a plurality of openings 10 leading into a molding chamber 11 of a tool 2. The molding chamber 11 is designed as a negative mold of the component 8 to be produced. In the exemplary embodiment of FIG. 2, it is provided that an opening 10 can be used to guide liquid material into the molding chamber 11. It can be advantageous to use a plurality of sprues for filling the molding chamber 11 in order to achieve a uniform temperature distribution and to reduce turbulences in the melt. A uniform temperature distribution and a small number of turbulences lead to a better cooling operation, to homogeneous cooling and thus to uniform amorphous material properties.

Within the molding chamber 11, the liquid material must quickly cool in order to prevent crystallization. The cooling of the liquid material depends greatly on the geometry of the component or workpiece 8 to be produced.

FIG. 3 shows a system 20 with which the mechanical properties of a component 8 to be produced can be determined or indicated. The system 20 comprises a simulation unit 23, a computing unit 24 and a prediction unit 27. Using an input unit 21, a user can transmit a component description 50, for example in the form of a CAD model, to the simulation unit 23 via a communication network 22. For example, the user can upload the component description 50 to a server via a web interface. The server can run a web server for this purpose. Subsequently, the server can transmit the component description 50 to the simulation unit 23.

The simulation unit 23 is designed to determine a cooling behavior of at least a part of a component 8 to be produced. In the exemplary embodiment shown, the component 8 to be produced is indicated by the component description 50. The determination of the cooling behavior by the simulation unit 23 is described in detail in FIGS. 6 and 7.

The simulation unit 23 is in particular designed to determine the temperature behavior for a specific production method. In this case, the simulation unit 23 can also be designed to determine an injection operation and/or the temperature behavior during an injection operation by means of a stamp 7. In particular, the simulation unit 23 can be designed to determine the temperature after the injection operation. This temperature can be used as the initial temperature in order to determine a cooling rate. In order to ensure amorphous properties of the component 8 to be produced, it is advantageous if the temperature after injection is higher than a threshold value, for example 850° C.

Starting from the initial temperature, the cooling behavior can be determined subsequently by the simulation unit 23.

The temperature behavior can, for example, be stored as a vector which contains elements indicating temperatures at specific points in time.

The computing unit 24 is designed to determine at least one amorphicity value 29 for at least a part of the component 8 to be produced. In this case, the computing unit 24 can calculate a single amorphicity value 29 for the entire component 8 to be produced or a plurality of amorphicity values 29 for different regions of the component 8 to be produced. In particular, when the component description 50 indicates a plurality of volume elements, the computing unit 24 can be designed to determine an amorphicity value 29 for each volume element.

In the exemplary embodiment shown, the computing unit 24 is designed to determine the at least one amorphicity value 29 by comparing a cooling rate, which can be indicated by the cooling behavior, with a critical cooling rate 30. If the determined cooling rate is above the critical cooling rate 30, amorphous properties are achieved in the component 8 to be produced. If the determined cooling rate is below the critical cooling rate 30, no amorphous properties are achieved in the component 8 to be produced. Depending on the magnitude of the deviation of the determined cooling rate from the critical cooling rate 30, the amorphicity value 29 can have a low or a high value. For example, a low amorphicity value can be determined when the determined cooling rate is significantly below the critical cooling rate 30. A high amorphicity value can be determined when the determined cooling rate is significantly above the critical cooling rate 30.

In the exemplary embodiment shown, the computing unit 24 is designed to query the critical cooling rate 30 for a specific alloy or for a specific material from the database unit 25. For this purpose, the database unit 25 stores the corresponding critical cooling rates 30 for a plurality of alloys or materials.

Furthermore, it is conceivable for the amorphicity value 29 to contain an indication of how many regions of the component 8 to be produced have amorphous properties. For example, the amorphicity value 29 can be interpreted as a percentage indicating which proportion of volume elements of the component description 50 or of the associated sub-regions of the component 8 to be produced will have amorphous properties.

The prediction unit 27 is designed to read material properties 32 from the database unit 25 for the determined amorphicity value 29 and a corresponding material or a corresponding alloy. The database unit 25 is designed to store a plurality of material properties 32 for pairs of amorphicity values and an alloy or a material.

Using the queried material properties 32, the prediction unit 27 is now able to determine mechanical properties 26 for the component 8 to be produced or the component description 50.

Furthermore, the prediction unit 27 is designed to check whether the mechanical properties 26 of the component 8 to be produced withstand user-defined load cases. If this is the case, a production system, for example an injection molding machine 28, can produce the component 8 using the corresponding production parameters 31. Furthermore, it is possible for the prediction unit 27 to be designed to transmit the mechanical properties 26 to the user terminal 21 via the communication network 22.

FIG. 4 shows a table 32 which can be stored by the database unit 25.

Table 32 comprises columns with information about amorphicity values, tensile strength values, flexural strength values, viscosity values, and/or alloys. In particular, an assignment of alloy and amorphicity value to material properties thus takes place. The table 30 thus comprises two rows for the alloy L1 to which different amorphicity values are assigned. Different material properties arise therefrom, such as tensile strength and flexural strength. Thus, a tensile strength ZW1 and a flexural strength BW1 and a viscosity VW1 are stored for an alloy L1 and an associated amorphicity value AW1. For the alloy L1, a tensile strength ZW2, a flexural strength BW2 and a viscosity VW2 are stored accordingly for a second amorphicity value AW2.

Material properties can thus be queried by a query to the database unit 25 by means of a tuple, which indicates an amorphicity value and an alloy.

FIG. 5 shows a second database table 33 which stores assignments of critical cooling rates to alloys. As can be seen from FIG. 5, a critical cooling rate AR1 is assigned to an alloy L1. This enables the computing unit 24 to read a corresponding critical cooling rate A1 for a specific alloy L1.

FIG. 6 shows an exemplary temperature profile 40. The exemplary embodiment of FIG. 6 relates to the inner part of the component 8 to be produced. As shown, the temperature drops from an initial temperature C1 at a time t1 to a temperature C2 reached at a time t2.

It is therefore possible to determine a cooling rate, which indicates the temperature drop, i.e., the temperature difference C1-C2, in the interval from t1 to t2. Furthermore, it is possible to ascertain whether the cooling rate is high enough to prevent crystallization. The cooling rate at which crystallization is prevented can be referred to as critical cooling rate. It is therefore possible to determine whether the cooling rate at each point of the component is greater than the critical cooling rate in order to ascertain whether a component or workpiece to be produced will have amorphous properties.

The temperature profile 40 thus describes the cooling behavior of a part of a component 8 to be produced. The computing unit 24 can therefore determine, by comparing with the critical cooling rate AR1 queried from the database unit 25 using the temperature profile 40, whether the component 8 to be produced will have amorphous properties according to the component description 50.

Components can be described digitally by a component description 50, for example with a CAD file. Thus, FIG. 7 shows a component description 50 of a cuboid, said description being constructed from a plurality of volume elements 51, 52. The component description 50 can therefore be, for example, a CAD model which is divided into individual volume elements 51, 52 using simulation software. The temperature behavior can now be simulated or predicted for each volume element 51, 52 of the component description 50.

Thus, FIG. 7 shows that a first temperature profile 53 is assigned to a first volume element 51. A second temperature profile 54 is assigned to a second volume element 52. The temperature profiles 53, 54 show the temperature drop from an initial temperature C1 to a limit temperature C2. The material of the component 8, which is indicated by the component description 50, has, for example, a temperature of about 850° C. when it was injected into the mold 2. The glass transition temperature of an exemplary Zr-based alloy is approximately 410° C. If the material is cooled down rapidly enough to below the critical temperature, i.e., glass transition temperature, amorphous structures are obtained. Should the critical cooling rate be fallen short of, the melt solidifies in the crystalline state and not in the amorphous state.

As can be seen from FIG. 7, in the first temperature profile 53, the limit temperature C2 is reached at a time t2. In the second temperature profile 54, the limit temperature C2 is reached at a time t3. As can be seen from the first and second temperature profiles 53, 54, the time t3 is before the time t2. This means that the temperature in the temperature profile 53, which is assigned to the first volume element 51, drops more slowly than in the second temperature profile 54, which is assigned to the second volume element 52. The cooling rate in the second temperature profile 54 is therefore greater than in the first temperature profile 53. If it is assumed that the cooling rate in the first temperature profile 53 is less than the critical cooling rate required to obtain amorphous structures, the component description 50 must be adapted to convey the heat out of the component more quickly so that the cooling rate at the point of the first volume element 51 is greater than the critical cooling rate. For this purpose, for example, a different alloy with a different critical cooling rate can be used.

The temperature diagrams 53 and 54 can be generated using a simulation unit 23. This means that a simulation of the temperature behavior is carried out for each volume element 51, 52. It is thus possible to determine the temperature diagrams 53 and 54 very precisely. The results of the simulation unit 23 can be provided digitally as cooling behavior, for example as an object in an object-oriented programming language. However, it is also possible for the cooling behavior to be provided as a text file or in any other format.

By considering individual volume elements 51, 52, it is also possible to determine amorphicity values 29 for each individual volume element 51, 52. In particular, it is possible to identify individual volume elements for which the critical cooling rate 30 is not reached. Furthermore, it is possible to ascertain which parts of the component description 50 have which material properties. This can be done using the database unit 25 and the prediction unit 27.

If crystalline structures occur, for example, in some regions of the produced component, there may be a particular risk of breakage for specific applications.

FIG. 8 illustrates a load case 60, which the behavior of the component 8 to be produced in the case of an applied force F. In FIG. 8, the component 8 is fixed on the right side thereof to a wall 61. The prediction unit 27 determines for the component 8 to be produced that during production, a crystalline region 62 will form on the component 8 to be produced. It can now be simulated by the prediction unit 27 whether the component 8 to be produced withstands defined load cases despite the crystalline region 62. If a simulation ascertains that the component 8 to be produced withstands the load case 60, the component 8 to be produced can be produced. By contrast, if it is ascertained that the component 8 to be produced does not withstand the load case, a different alloy can be selected, for example, in order to prevent the formation of the crystalline region 62.

On the left side thereof, a force F acting from below is indicated by the load case 60. Using a simulation, the behavior of the component 8 to be produced in response to this force F can be calculated. Due to the force F being applied to the left side and the fixing of the component 8 on the right side, the component 8 to be produced bends. In the exemplary embodiment shown in FIG. 8, it is assumed that the component 8 to be produced does not withstand the load case, and a break occurs at the crystalline region 62.

The prediction unit 27 is now designed to activate the simulation unit 23. In this case, an indication that the previously selected alloy is not sufficient is transmitted to the simulation unit 23. The simulation unit 23 is therefore designed to determine the cooling behavior for a second alloy and to adapt the component description 50 accordingly so that the component description 50 includes the corresponding information.

FIG. 9 shows a flow chart for a method 70 for producing a component 79. In an input step 71, a user defines a component description 72 which describes a component 8 to be produced. The component description 72 can be transmitted via a communication network to a simulation unit 24. In the simulation step 73, a simulation unit 24 can determine/simulate a temperature behavior 74 for the component description 72.

In step 75, the temperature behavior is used to determine at least one amorphicity value 76. For this purpose, a critical cooling rate for an alloy indicated by the component description 72 can be read from a database unit 25.

In comparison step 77, the determined amorphicity value 76 is compared with a setpoint value or determined mechanical properties of the component 8 to be produced are checked for load cases. If it is ascertained that the amorphicity value 76 does not meet the requirements of the setpoint value, or that the component 8 to be produced does not satisfy the load cases, the method is continued in step 73. For this purpose, the method is restarted in the simulation step 73 with an alloy that has not yet been used, since a different temperature behavior and a different critical cooling rate apply to said alloy.

If it is ascertained that the amorphicity value 76 meets the requirements of the setpoint value or the component 8 to be produced satisfies the load cases, the component 79 can be produced in the manufacturing step 78 using the component description 72.

It should be noted at this juncture that all parts described above are each in their own right—even without the features additionally described in the respective context, even if they have not been explicitly identified individually as optional features in the respective context, for example by the use of: in particular, preferably, for example, e.g., optionally, round brackets, etc., —and in combination or any sub-combination to be considered independent embodiments or developments of the invention, as it is defined in particular in the introduction to the description and the claims. Deviations therefrom are possible. Specifically, it should be noted that the phrase “in particular” or round brackets do not denote any features that are mandatory in the respective context.

### LIST OF REFERENCE SIGNS

1 Injection molding machine
2 Mold
3 Melting chamber
4, 4′ Heating element
5 Feed hopper
6 Screw
7 Stamp
8 Liquid starting material
9 Line system
10, 10′, 10″, 10′″ Inlet opening
11 Molding chamber
20 System
21 Input unit
22 Communication network
23 Simulation unit
24 Computing unit
25 Database unit
26 Mechanical properties
27 Prediction unit
29, 75 Amorphicity value
30 Critical cooling rate
31 Production parameter
32 Database table
33 Database table
40, 74 Temperature profile
50, 72 Component description/CAD model
51 First volume element
52 Second volume element
53 First temperature diagram
54 Second temperature diagram
60 Load case
61 Wall
62 Crystalline region
70 Method
71 Input step
73 Simulation step
77 Comparison step
78 Production step
79 Produced component
C1 Initial temperature
C2 Target temperature
T1, T2 Time
AW1, AW2, AW3 Amorphicity value
ZW1, ZW2, ZW3 Tensile strength value
BW1, BW2, BW3 Flexural strength value
VW1, VW2, VW3 Viscosity value
L1, L2 Alloy

1. A system having the following:
a simulation unit which is designed to determine a cooling behavior of at least a part of a component to be produced, said component having amorphous properties;
a computing unit which is designed to determine at least one amorphicity value at least for a part of the component to be produced, taking account of the determined cooling behavior; and
a prediction unit which is designed to indicate mechanical properties of the component to be produced, taking account of a geometry of the component to be produced, the at least one amorphicity value, at least one production parameter and/or a production method.

2. The system according to claim 1, wherein
a database unit which is designed to store assignments of material properties and/or material information to amorphicity values.

3. The system according to claim 1, wherein
the computing unit is further designed to determine a cooling rate of at least a part of the component to be produced, taking account of the determined cooling behavior.

4. The system according to claim 3, wherein
the computing unit is further designed to compare a/the determined cooling rate with a critical cooling rate, in particular one that is alloy-dependent, wherein the computing unit is designed to carry out the determination of the amorphicity value, taking account of the comparison.

5. The system according to claim 4, wherein
the database unit is designed to store an assignment of material properties to, critical cooling rates and/or amorphicity values.

6. The system according to claim 1, wherein
the component to be produced is indicated by a component description, in particular by a CAD model, wherein the simulation unit is designed to carry out the determination of the cooling behavior using the component description.

7. The system according to claim 6, wherein
a/the component description indicates a plurality of volume elements, wherein the simulation unit is designed to determine a cooling behavior for at least a part of the volume elements, preferably for all volume elements.

8. The system according to claim 1, wherein
the prediction unit is designed to simulate at least one mechanical load case for the component to be produced, in particular using a/the component description and/or an FEM simulation.

9. The system according to claim 1, wherein
a production plant designed to produce the component to be produced using the at least one production parameter, in particular by an additive manufacturing method or an injection molding method.

10. A method for indicating mechanical properties for a component to be produced, said component having amorphous properties, having the steps of:
determining a cooling behavior of at least a part of a component to be produced, said component having amorphous properties;
determining at least one amorphicity value at least for a part of the component to be produced, taking account of the determined cooling behavior; and,
indicating mechanical properties of the component to be produced, taking account of a geometry of the component to be produced, the at least one amorphicity value, at least one production parameter and/or a production method.

11. The method according to claim 10, wherein
storing assignments of material properties and/or materials to amorphicity values.

12. The method according to claim 10, wherein
determining a cooling rate for at least a part of the component to be produced, taking account of the simulated cooling behavior.

13. The method according to claim 10, wherein
comparing the determined cooling rate with a critical cooling rate, in particular one that is alloy-dependent, wherein the amorphicity value is determined taking account of the comparison.

14. The method according to claim 10, wherein
storing an assignment of material properties to critical cooling rates and/or amorphicity values, in particular in a database unit.

15. The method according to claim 10, wherein
the component to be produced is indicated by a component description, in particular by a CAD model, wherein the cooling behavior is determined using the component description.

16. The method according to claim 15, wherein
the component description indicates a plurality of volume elements, wherein the determination of the cooling behavior comprises determining the cooling behavior for at least a part of the volume elements, preferably for all volume elements.

17. The method according to claim 10, wherein
simulating at least one mechanical load case for the component to be produced, in particular using a component description and/or an FEM simulation.

18. The method according to claim 10, wherein
producing the component to be produced using the at least one production parameter, in particular by an additive manufacturing method or an injection molding method.

19. A computer-readable storage medium containing instructions which cause the at least one processor to implement a method according to claim 10 when the instructions are executed by the at least one processor.
